(19) United States
(12) Patent Application Publication
(10) Pub. No.: US 2005/0201277 A1
(43) Pub. Date: Sep. 15, 2005

(54) Communication method and apparatus

(75) Inventor: Kazuhiro Ohnuma, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/873,148

(22) Filed: Jun. 23, 2004

(30) Foreign Application Priority Data
Feb. 27, 2004 (JP) 2004-054439

(51) Int. Cl. H04J 1/16

(52) U.S. Cl. 370/227

(57) ABSTRACT

On a transmission side, phase information divided is sequentially inserted respectively into at least two predetermined bytes within a path overhead for each single frame of a transmission signal so as to compose a multiframe, and the transmission signal is branched into transmission lines of a working system and a protection system to be transmitted. On a reception side, a phase difference between the branched transmission signals of the working system and the protection system is detected based on the phase information detected for each of the predetermined bytes in the branched transmission signals respectively received from the transmission lines of the working system and the protection system, the branched transmission signals are stored respectively in memories of the working system and the protection system, phase adjustment signals are provided to the memories of the working system and the protection system based on the phase difference, the transmission signals in an in-phase state are outputted from the memories of the working system and the protection system based on the phase adjustment signals, and the transmission signal outputted from one of the memories of the working system and the protection system is selected.

### BACKGROUND OF THE INVENTION

1. Field of the Invention

The present invention relates to a communication system, and in particular to a communication method and apparatus capable of switching uninterruptibly between a working and protection systems for long-distance transmission lines.

2. Description of the Related Art

An uninterruptible communication system, which provides a redundant arrangement of transmission lines so that the transmission line of a working system is switched over to that of a protection system in case a failure or the like occurs on the transmission line of the working system, has been adopted for conventional multiplexed transmission systems of SDH (Synchronous Digital Hierarchy)/SONET (Synchronous Optical Network).

A conventional uninterruptible communication system composes multiframes with input data of a J1 byte within a path overhead (hereinafter, occasionally abbreviated as POH) of an SDH frame on a transmission side and branches the multiframes into two paths to be transmitted, and establishes, on a reception side, a multiframe synchronization by the input data of the J1 byte for the signals respectively received from the two paths so as to absorb a phase difference detected therebetween (see e.g. patent document 1).

An arrangement of a transmitter adopting such an uninterruptible communication system which establishes a multiframe synchronization by input data of the J1 byte will now be described referring to FIG. 6.

A transmitter 10 shown in FIG. 6 is composed of an interface 11 for inputting data; a POH adder 12 and an SOH adder 14 for respectively adding a path overhead and a section overhead to the input data; a distributor 15 for branching the signal from the SOH adder 14 into a 0-system (e.g. working system) interface 16 and a 1-system (e.g. protection system) interface 17; and a phase information inserter 13 for providing phase information to the POH adder 12.

In operation, while a path overhead is added to each frame of the data inputted to the interface 11 in the POH adder 12, 64-multiframe phase information is inserted by the phase information inserter 13 into the J1 byte in the path overhead of the frame. Thereafter, in the SOH adder 14, a section overhead is added to the frame, and then branched by the distributor 15 to be transmitted as optical transmission signals of the 0-system and the 1-system respectively through the 0-system interface 16 that is the working system and the 1-system interface 17 that is the protection system.

FIG. 7 shows an arrangement of an STM-1 multiframe that is the base unit in the SDH as an example of a general SDH frame transmitted as an optical transmission signal. As shown, a frame is composed of a section overhead (SOH) and three virtual containers VC3#1-VC3#3. It is to be noted that a virtual container is a standardized unit for multiplexing.

A path overhead (POH) is added to each of the virtual containers VC3#1-VC3#3. While the path overhead (POH) is shown only within the virtual container VC3#1 in FIG. 7, the path overheads (POH's) are also added to the other virtual containers VC3#2 and VC3#3.

In the path overhead (POH), “bytes” such as a J1 byte, a B3 byte, a C2 byte, a G1 byte, an F2 byte, an H4 byte, an F3 byte, a K3 byte, an N1 byte are defined.

Among these, the phase information inserter 13 shown in FIG. 6 inserts into the J1 byte the phase information for composing a 64-multiframe, that is a multiframe composed of 64 single frames.

An example of J1 byte insertion in case of composing the conventional 64-multiframe will now be described referring to FIG. 8.

FIG. 8 schematically shows a state of frame data serially aligned and values of only a part of the J1 bytes.

Sequential values from “00” to “63” will be repeatedly inserted into the J1 bytes. Therefore, in FIG. 8, the values “63”, “00”, “01”, and “02” are sequentially inserted from the right to the left in the J1 bytes shown.

FIG. 9 shows a receiver capable of realizing such uninterruptible switching by using the 64-multiframe, namely the arrangement of a receiver 20 opposing the transmitter 10 shown in FIG. 6.

As shown in FIG. 9, the receiver 20 has a 0-system interface 21 and a 1-system interface 22 respectively receiving optical transmission signals of the 0-system and the 1-system and terminating section overheads (SOH's).

Elastic memories 25 and 26 are respectively connected to the 0-system interface 21 and the 1-system interface 22, and a selector 28 is commonly connected to both memories 25 and 26. Moreover, an interface 29 is connected to the selector 28.

Also, multiframe synchronous circuits 23 and 24 are respectively connected to outputs of the 0-system interface 21 and the 1-system interface 22. A control circuit 27 is commonly connected to the multiframe synchronous circuits 23 and 24 as well as the elastic memories 25 and 26.

While being in-phase at the time of output from the 0-system interface 16 and the 1-system interface 17 of the transmitter 10 shown in FIG. 6, the 0-system and 1-system optical transmission signals respectively received by the interfaces 21 and 22 are both the transmission signals composing the 64-multiframe shown in FIG. 8 and are in a state where the phases are mutually deviated due to a path length difference between the transmission lines at the time of reception.

For example, the phases of the transmission signals are mutually deviated in such a way that when the values of the J1 bytes shown in FIG. 8 are compared at some point, even if the value of the J1 byte of the transmission signal received by the 0-system interface 21 is “00”, the value of the J1 byte received by the 1-system interface 22 is “02”.

In this case, the transmission signal of the 1-system interface 22 has the phase preceding by 2 frames. This phase difference is detected by the multiframe synchronous circuits 23 and 24 as well as the control circuit 27. The control circuit 27 provides appropriate control information to the elastic memories 25 and 26, thereby making the signals inputted to the selector 28 in-phase. Therefore, by operating the selector 28 at a high speed with an external control, the signals can be switched from the 0-system to the 1-system uninterruptibly.

FIGS. 10A and 10B schematically shows an absorption of such a phase difference. FIG. 10A shows a state where the phase difference exists between the 0-system signal and the 1-system signal, which is a schematic illustration of the state of the signals received by the 0-system interface 21 and the 1-system interface 22 in FIG. 9. In FIG. 10A, one character of the alphabet represents data of one frame, and a cell including an alphabet represents one frame.

Therefore, while the 1-system signal is in the state where the phase precedes by 6 frames as shown by a dotted line in FIG. 10A with respect to the 0-system, in the state after the absorption of the phase difference shown in FIG. 10B, the 0-system signal and the 1-system signal are in an in-phase state. Namely, the state shown in FIG. 10B is the state of the signals outputted from the elastic memories 25 and 26.

While a basic uninterruptible communication system using the 64-multiframe synchronization has been described heretofore, there is another system enabling uninterruptible switching which supports asynchronous data and uninterruptible switching of data without a multiframe structure (see e.g. patent document 2).

There is still another system that matches the phases for multiframes of over 64 frames by making two of the J1 bytes a fixed byte and a variable byte such as an incremented counter value (see e.g. patent document 3).

[Patent document 1] Japanese patent application laid-open No. 05-183,464

[Patent document 2] Japanese patent application laid-open No. 11-205,267

[Patent document 3] Japanese patent application laid-open No. 2000-295,190

The phase deviation between the transmission signals received by the working system and the protection system is caused mainly by the path length difference of the transmission lines enabling the uninterruptible switching. Therefore, the uninterruptible communication system with the above-mentioned 64-multiframe synchronization using the J1 byte has a limit of the path length difference enabling the uninterruptible switching.

Namely, if one frame is of 125 μs, a phase difference Δt corresponding to the 64-multiframe is Δt=125 μs×64=8 ms. Since the signal transmission by an optical fiber requires 5 μs for 1 km, the path length difference enabling the uninterruptible switching assumes 8 ms/5 μs=1600 km by a simple calculation.

However, in case the longer one of the path lengths of the working and protection system transmission lines is known, this is a logical maximum value on the precondition that the phase of one of the transmission lines is fixed. Therefore, assuming that which transmission line has the preceded phase is unknown, the logical value assumes half of the above-mentioned value, that is 800 km. Furthermore, in view of other phase delaying factors, the actual path length difference enabling the uninterruptible switching assumes about 600 km.

FIGS. 11A and 11B show a redundant arrangement of the transmission lines. FIG. 11A shows a simple redundant arrangement in which transmission equipments 30 and 40, that are opposing transceivers, are mutually connected with a working 0-system transmission line T_0 and a protection 1-system transmission line T_1. In this case, if the path length difference between the 0-system transmission line T_0 and the protection 1-system transmission line T_1 is within 600 km, the above-mentioned uninterruptible switching by the 64-multiframe synchronization is possible.

However, in recent years, the long distance transmission is enabled by the optical fiber, so that as shown in FIG. 11B, when the opposing transmission equipments 30 and 40 are mutually connected with the 0-system transmission line T_0 and the 1-system transmission line T_1, the 0-system transmission line T_0 may be relayed by transmission equipments 50 and 60 and the 1-system transmission line T_1 may be relayed by transmission equipments 70, 80, and 90.

In this case, intervals between the transmission equipments 30, 50, 60, and 40 in the 0-system transmission line T_0 are section intervals 1-3 respectively, while intervals between the transmission equipments 30, 70, 80, 90, and 40 in the 1-system transmission line T_1 are section intervals 4-7 respectively. The interval between the transmission equipments 30 and 40 is a path interval 8.

In this case, the path length of the 0-system transmission line T_0 is the total of the path lengths of the section intervals 1-3, and the path length of the 1-system transmission line T_1 is the total of the path lengths of the section intervals 4-7.

Therefore, in case of an arrangement of FIG. 11B where a plurality of transmission equipments intervene, there is a high possibility that the path length difference between the 0-system transmission line T_0 and the 1-system transmission line T_1 exceeds 600 km, whereby the above-mentioned uninterruptible switching by the 64-multiframe synchronization is disabled.

On the other hand, according to the above-mentioned patent document 3, it is possible to extend the path length difference up to 265,000 km. However, the technology of the patent document 3 is required to be applied to all of the uninterruptible communication equipments within the system, so that there is no upward compatibility for the conventional communication equipment performing the 64-multiframe synchronization by inserting phase information into the J1 byte as shown in FIG. 8.

Namely, in such a system having the arrangement shown in FIG. 11B where both of the opposing transmission equipments 30 and 40 use the 64-multiframe shown in FIG. 8, the technology of the patent document 3 cannot be only applied to either one of the transmission equipments.

This is because the last two bytes of the J1 bytes are made the fixed byte and the variable byte such as the incremented counter value in the 64-multiframe of the patent document 3 so that at least the last two bytes thereof are different from those of the 64-mutiframe shown in FIG. 8.

Thus, the receiver of the patent document 3 which receives the 64-multiframe from the conventional transmitter cannot perform the 64-multiframe synchronization. On the contrary, the conventional receiver which receives the 64-multiframe from the transmitter of the patent document 3 cannot perform the 64-multiframe synchronization either.

### SUMMARY OF THE INVENTION

It is accordingly an object of the present invention to enable an uninterruptible communication in transmission lines of a redundant arrangement having a path length difference exceeding 600 km, and to provide upward compatible communication methods and apparatuses.

In order to achieve the above-mentioned object, a communication method according to the present invention comprises the steps of sequentially inserting, on a transmission side, phase information divided respectively into at least two predetermined bytes within a path overhead for each single frame of a transmission signal so as to compose a multiframe; branching the transmission signal into transmission lines of a working system and a protection system to be transmitted; detecting, on a reception side, a phase difference between the branched transmission signals of the working system and the protection system based on the phase information detected for each of the predetermined bytes in the branched transmission signals respectively received from the transmission lines of the working system and the protection system; storing the branched transmission signals respectively in memories of the working system and the protection system; providing phase adjustment signals to the memories of the working system and the protection system based on the phase difference; outputting the transmission signals in an in-phase state from the memories of the working system and the protection system based on the phase adjustment signals; and selecting the transmission signal outputted from one of the memories of the working system and the protection system.

Namely, on the transmission side, by sequentially inserting phase information divided respectively into at least two predetermined bytes within a path overhead of each single frame of the transmission signal, at least two tiers of multiframes are composed. Then, the transmission signal is branched into transmission lines of a working system and a protection system to be transmitted.

On the reception side, there is a phase difference between the branched transmission signals respectively received from the transmission line of the working system and the protection system. Therefore, the phase difference between the branched transmission signals is detected based on the phase information detected for each of the predetermined bytes of the transmission signals and the transmission signals are stored respectively in the memories of the working system and the protection system. Phase adjustment signals for phase synchronization based on the phase difference are provided to the memories of the working system and the protection system, so that the transmission signals in anin-phase state based on the phase adjustment signals are outputted from the memories of the working system and the protection system, and one of the transmission signals outputted is selected therefrom.

Hereinafter, the steps on the above-mentioned transmission side and the reception side will be more specifically described referring to drawings.

FIGS. 1A-1D schematically show an arrangement of a multiframe composed on the above-mentioned transmission side. An example of a 4-tiered multiframe composed by inserting phase information divided into the J1 byte and the F2 byte of the path overhead is shown in FIGS. 1A-1D.

It is to be noted that while the 4-tiered multiframes are composed in FIGS. 1A-1D, at least two tiers of multiframes can be composed by using at least two bytes of a path overhead (for example, J1 byte and F2 byte).

As shown in FIG. 1A, in the tier-1 of the multiframe, values of “00”-“63” divided are sequentially inserted as the phase information into the J1 byte of the frame and the value of “00” indicating the tier-1 is inserted as the phase information into the F2 byte respectively.

In FIGS. 1B-1D respectively, inserted states of the phase information in each of the J1 bytes and the F2 bytes are shown for the tier-2 to the tier-4. While the state of the J1 byte is the same as that of FIG. 1A, the values counted up from “01” to “03” as the number of tiers increases are inserted into the F2 bytes.

On the above-mentioned transmission side, a transmission signal in a state having the multiframe as shown in FIGS. 1A-1D composed is branched into the transmission lines of the working system and the protection system to be transmitted.

On the other hand, on the receiving side, the branched transmission signals are received from the transmission lines of the working system and the protection system. Due to the difference in the distances of the transmission lines, the respective transmission signals are in a state where the phases of the multiframe shown in FIG. 1A-1D are shifted. For example, when a combination of the J1 byte and the F2 byte representing the phase information of the received transmission signals from the transmission lines of the working system and the protection system are respectively J1=“00” & F2=“00” and J1=“01” & F2=“01”. The transmission signal from the protection system transmission line precedes by the phase of 66 frames by the conversion into single frames.

Namely, the detection of the phase difference is made possible based on the phase information of combination of J1 byte and the F2 byte. Also, since the phase adjustment signals based on the detected phase difference are provided to the memories of the working system and the protection system, the transmission signals in the in-phase state can be outputted from the memories of the working system and the protection system.

In this case, the transmission signals outputted from the memories of the working system and the protection system are in the state where the phase is matched so that the combinations of the values of the J1 byte and the F2 byte in FIGS. 1A-1D may be identical. In the above-mentioned example, when the phase information of the transmission signal received from the transmission line of the working system becomes J1=“01” & F2=“01”, the transmission signals are outputted from the memories of the working system and the protection system.

Thus, the transmission signals outputted respectively from the memories of the working system and the protection system are in the in-phase state. Therefore, when switching over the output from one memory to the other, the uninterruptible switching is made possible.

In this case, an absorption is made possible for a phase difference of a multiframe in the length of more than two times (four times in the example of FIGS. 1A-1D) the multiframe composed by only one byte of the path overhead. Therefore, the uninterruptible communication is enabled in the redundant arrangement of transmission lines having the path length difference exceeding 600 km which has been difficult by the conventional 64-multiframe by using, for example, only the J1 byte.

Also, by focusing attention on the J1 byte only in the FIGS. 1A-1D, it is the same as the conventional 64-multiframe. Therefore, it becomes possible to achieve an upward compatibility.

The above-mentioned predetermined bytes may include at least a J1 byte and an F2 byte, and the multiframe may comprise tiers of 64-multiframes by the J1 byte assembled by an arbitrary number of tiers identifiable by at least the F2 byte.

Namely, the predetermined bytes include the J1 byte and the F2 byte. The multiframe is composed by assembling an arbitrary number of tiers identifiable by the F2 byte only or by the combination of the F2 byte and the other bytes for the 64-multiframe by the J1 byte.

Thus, a phase difference of at least more than two times the conventional 64-multiframe can be absorbed, thereby enabling an uninterruptible communication in the transmission line of the redundant arrangement having a path length difference exceeding 600 km which has been difficult in the prior art.

Also, the step of setting and changing the arbitrary number of tiers on the transmission side may be further provided.

Namely, since the arbitrary number of tiers can be variously specified by a number of effective bits in the F2 byte or by a method of combination with other bytes, the step of setting and changing the arbitrary number of tiers may be provided. Thus, it is made possible to compose a multiframe of an appropriate number of tiers according to the difference between the distances of the transmission lines of the working system and the protection system.

Also, a transmission method may comprise the steps of: sequentially inserting phase information divided respectively into at least two predetermined bytes within a path overhead for each single frame of a transmission signal so as to compose a multiframe; and branching the transmission signal into transmission lines of a working system and a protection system to be transmitted.

Moreover, a reception method may comprise the steps of: detecting a phase difference between transmission signals of a working system and a protection system based on phase information of a multiframe detected per at least two predetermined bytes within a path overhead for each single frame of the transmission signals respectively received from transmission lines of the working system and the protection system; storing the transmission signals respectively in memories of the working system and the protection system; providing phase adjustment signals to the memories of the working system and the protection system based on the phase difference; outputting the transmission signals in an in-phase state from the memories of the working system and the protection system based on the phase adjustment signals; and selecting the transmission signal outputted from one of the memories of the working system and the protection system.

An apparatus realizing the above-mentioned uninterruptible communication method comprises: a phase information inserter sequentially inserting, on a transmission side, phase information divided respectively into at least two predetermined bytes within a path overhead for each single frame of a transmission signal so as to compose a multiframe; a distributor branching the transmission signal into transmission lines of a working system and a protection system to be transmitted; a phase difference detector detecting, on a reception side, a phase difference between the branched transmission signals of the working system and the protection system based on the phase information detected for each of the predetermined bytes in the branched transmission signals respectively received from the transmission lines of the working system and the protection system; a memory controller outputting phase adjustment signals of the working system and the protection system based on the phase difference; memories of the working system and the protection system respectively storing the transmission signals of the working system and the protection system and then respectively outputting the transmission signals in an in-phase state based on the phase adjustment signals; and a selector selecting the transmission signal outputted from one of the memories of the working system and the protection system.

In this case, the predetermined bytes may include at least a J1 byte and an F2 byte, and the multiframe may comprise tiers of 64-multiframes by the J1 byte assembled by an arbitrary number of tiers identifiable by at least the F2 byte.

The above-mentioned communication apparatus may further comprise means setting and changing the arbitrary number of tiers on the transmission side.

A transmitter realizing the above-mentioned transmission method may comprise: a phase information inserter sequentially inserting phase information divided respectively into at least two predetermined bytes within a path overhead for each single frame of a transmission signal so as to compose a multiframe; and a distributor branching the transmission signal into transmission lines of a working system and a protection system to be transmitted.

In this case, the predetermined bytes may include at least a J1 byte and an F2 byte; and the phase information inserter may comprise at least a first and second insertion counters respectively providing a first and second counts as the phase information to be inserted into the J1 byte and the F2 byte, and a counter controller controlling operations of the first and second insertion counters so as to compose the multiframe.

Also, a setting portion setting a maximum value of the second insertion counter may be further provided.

Also, a receiver realizing the above-mentioned receiving method may comprise: a phase difference detector detecting a phase difference between transmission signals of a working system and a protection system based on phase information of a multiframe detected per at least two predetermined bytes within a path overhead for each single frame of the transmission signals respectively received from transmission lines of the working system and the protection system; a memory controller outputting phase adjustment signals of the working system and the protection system based on the phase difference; memories of the working system and the protection system respectively storing the transmission signals of the working system and the protection system and then respectively outputting the transmission signals in an in-phase state based on the phase adjustment signals; and a selector selecting the transmission signal outputted from one of the memories of the working system and the protection system.

In this case, the predetermined bytes may include at least a J1 byte and an F2 byte; and the phase difference detector may comprise, in each of the working system and the protection system, at least a first and second detection counters respectively detecting the phase information from the J1 byte and the F2 byte of the transmission signal as a first and second counts, and a third detection counter detecting phase information of the multiframe based on the first and second counts.

Moreover, when the second detection counter notifies the third detection counter that the phase information is not inserted in the F2 byte, the third detection counter may detect the phase information of the multiframe based on only the first count.

The present invention enables an uninterruptible communication even if a path length difference between the transmission lines of the working system and the protection system exceeds 600 km, and realizes an upward compatibility.

### BRIEF DESCRIPTION OF THE DRAWINGS

The above and other objects and advantages of the invention will be apparent upon consideration of the following detailed description, taken in conjunction with the involving drawings, in which the reference numerals refer to like parts throughout and in which:

FIGS. 1A-1D are diagrams showing a phase information insertion example in the present invention;

FIG. 2 is a block diagram showing an embodiment of a transmitter according to the present invention;

FIG. 3 is a block diagram showing an embodiment of a receiver according to the present invention;

FIG. 4 is a block diagram showing a modification of a transmitter according to the present invention;

FIG. 5 is a block diagram showing a modification of a receiver according to the present invention;

FIG. 6 is a block diagram showing an arrangement of a conventional transmitter;

FIG. 7 is a diagram showing a general arrangement of an SDH frame;

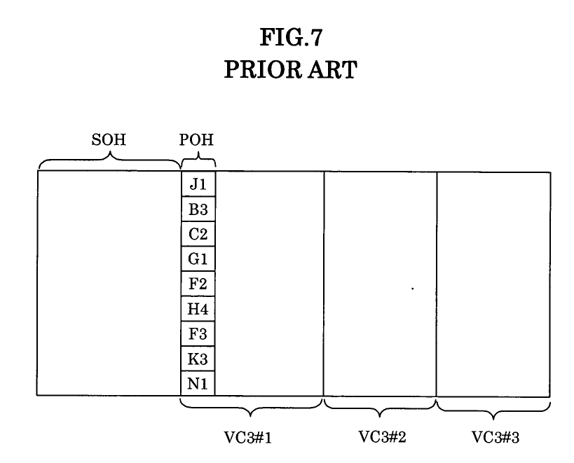

FIG. 8 is a diagram showing a J1 byte insertion example in a conventional 64-mutiframe;

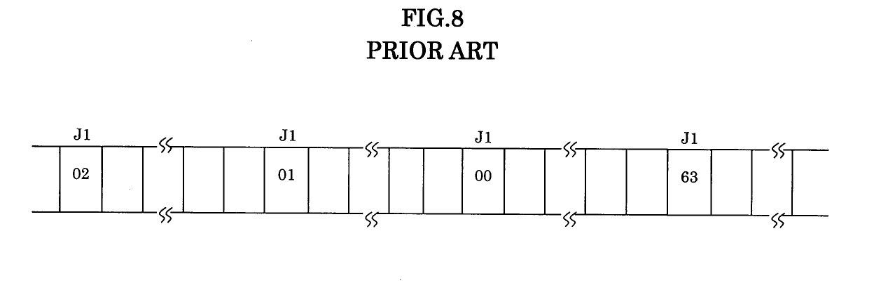

FIG. 9 is a block diagram showing an arrangement of a conventional receiver;

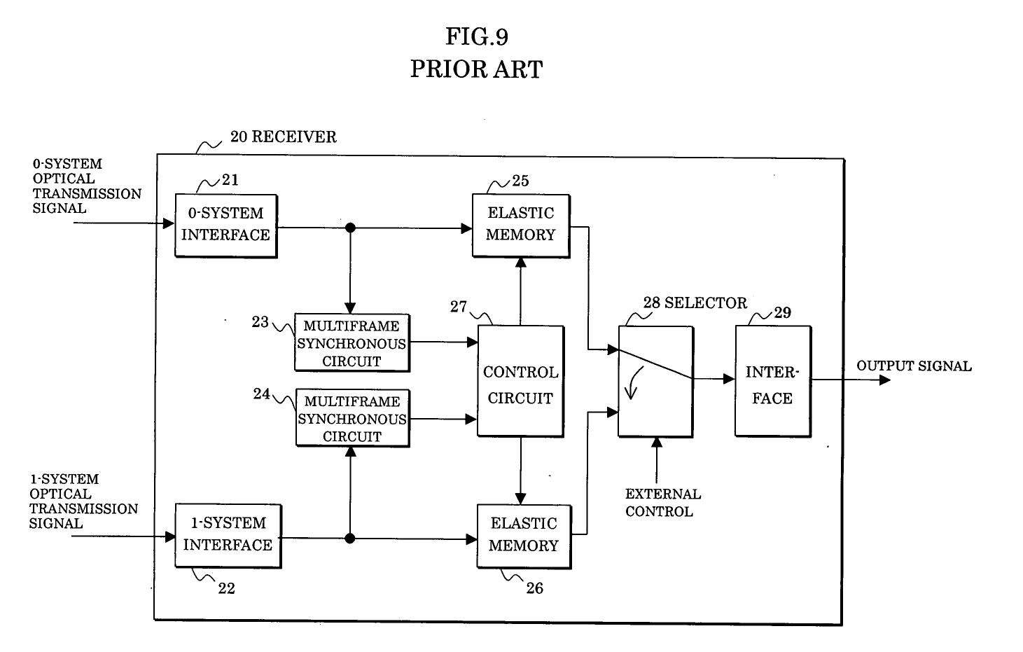

FIGS. 10A and 10B are diagrams schematically illustrating general phase difference absorption; and

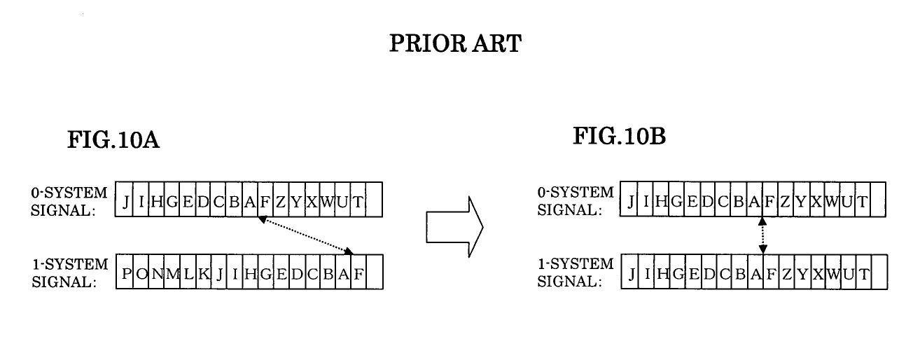

FIGS. 11A and 11B are block diagrams showing examples of redundant arrangement of transmission lines.

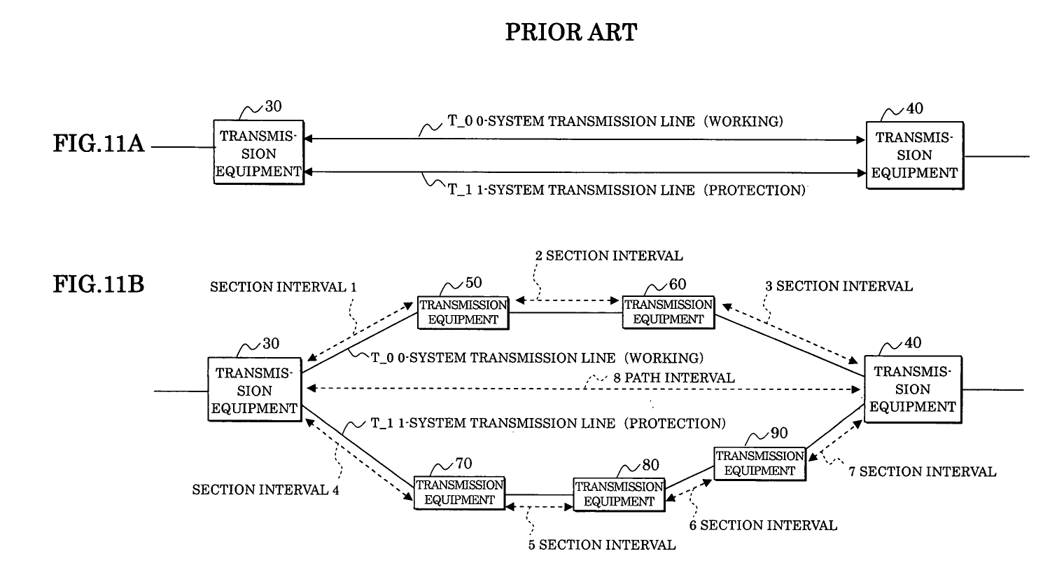

### DESCRIPTION OF THE EMBODIMENTS

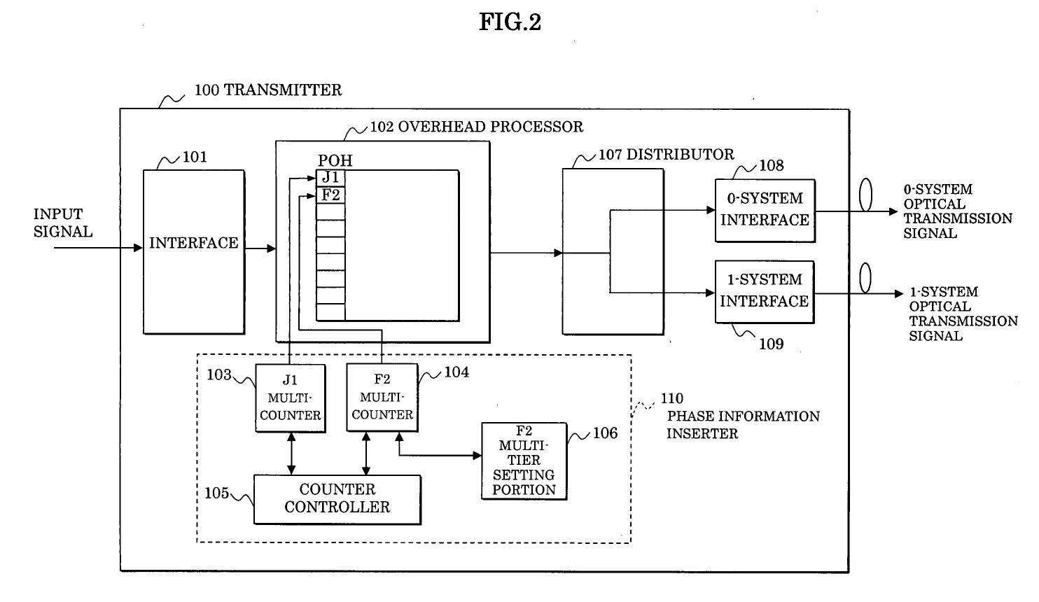

FIG. 2 shows an arrangement of a transmitter 100 as an embodiment of a transmitter according to the present invention.

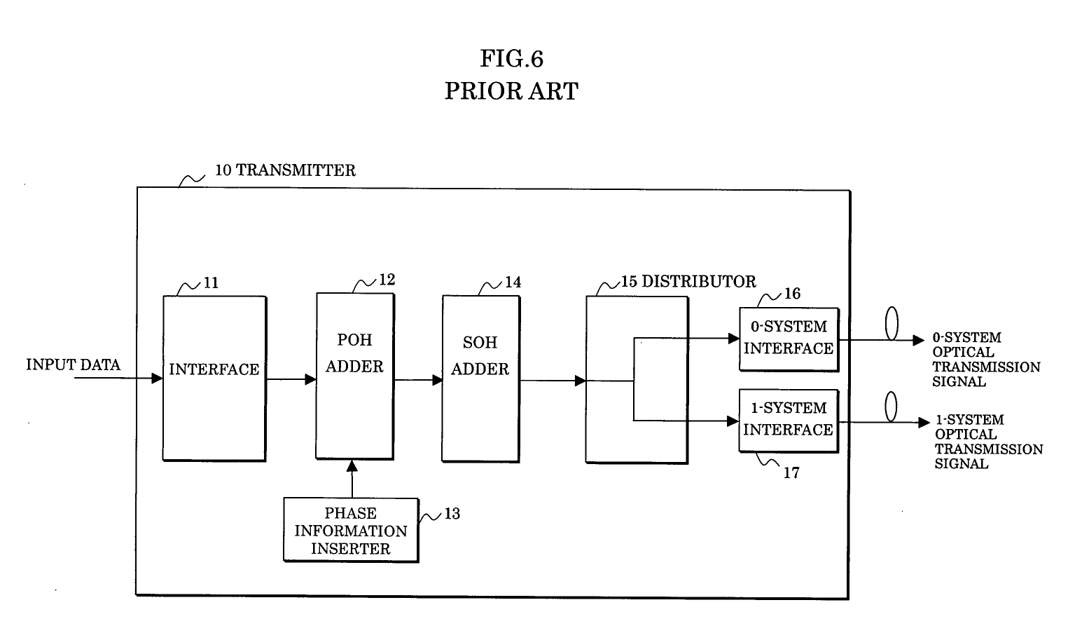

FIG. 2 will be described in comparison with the conventional transmitter 10 shown in FIG. 6. An interface 101, a distributor 107, a 0-system interface 108, and a 1-system interface 109 shown in FIG. 2 respectively correspond to the interface 11, the distributor 15, the 0-system interface 16, and the 1-sytem interface 17 shown in FIG. 6.

While an overhead processor 102 in FIG. 2 is the integration of the POH adder 12 and the SOH adder 13 in FIG. 6, it may be arranged in a discrete arrangement as in FIG. 6.

Also, a phase information inserter 110 in FIG. 2 corresponds to the phase information inserter 13 of FIG. 6. While the phase information inserter 13 inserts the phase information only in the J1 byte of the path overhead, the phase information inserter 110 inserts the phase information in the J1 byte and the F2 byte.

Therefore, as shown in FIG. 2, the phase information inserter 110 is provided with a J1 multi-counter 103 for inputting the phase information to the J1 byte, an F2 multi-counter 104 for inputting the phase information to the F2 byte, and a counter controller 105 for controlling both counters 103 and 104.

While an F2 multi-tier setting portion 106 for setting the number of tiers of the multiframes to be counted by the F2 multi-counter 104 is provided, it is needless to provide the F2 multi-tier setting portion 106 when the number of tiers is fixed.

In operation, in the overhead processor 102, a path overhead (POH) and a section overhead (SOH) are added to the input signal inputted to the interface 101. It is to be noted that the contents of the addition of the section overhead are omitted in FIG. 2.

As shown in FIG. 2, the counter controller 105 controls the J1 multi-counter 103 and the F2 multi-counter 104 to compose a multiframe, and sequentially inserts the phase information into the J1 byte and the F2 byte of the path overhead of the frame.

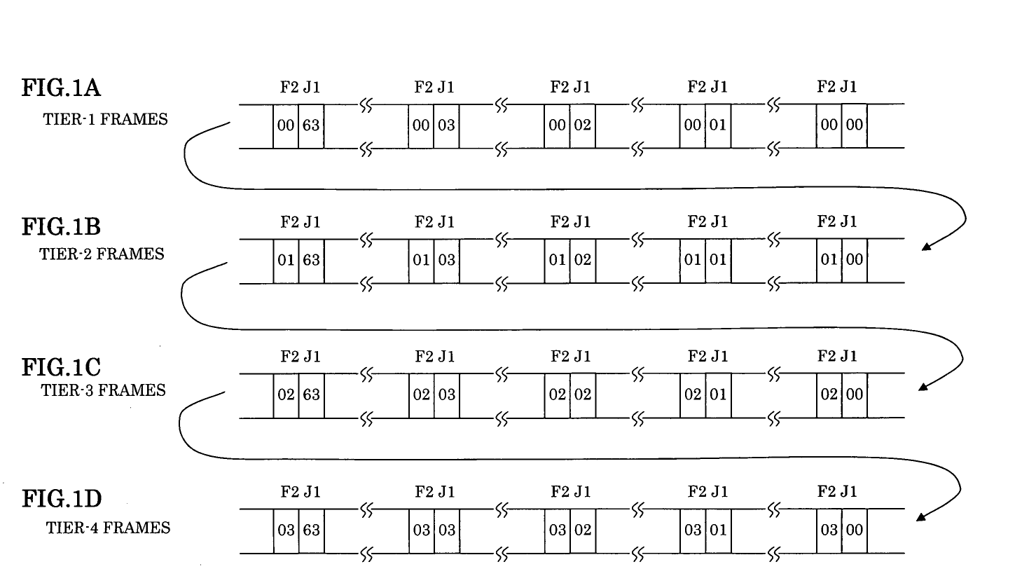

For example, if the multi-tier number set to the F2 multi-counter 104 by the F2 multi-tier setting portion 106 is “4”, the specific examples of the J1 byte and the F2 byte inserted are the same as the multiframe arrangement described in FIGS. 1A-1D.

The output signal from the overhead processor 102 is branched by the distributor 107, and transmitted to the transmission lines as a 0-system optical transmission signal and a 1-system optical transmission signal through the 0-system interface 108 and the 1-system interface 109.

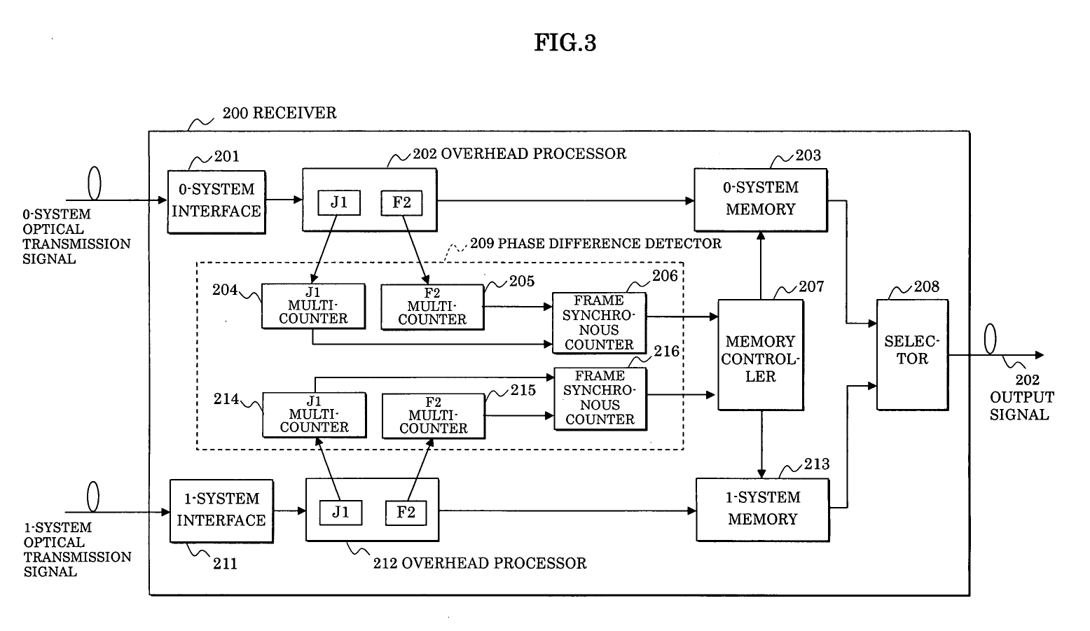

FIG. 3 shows the receiver 200 opposing the above mentioned transmitter 100 as an embodiment of a receiver according to the present invention. The receiver 200 in FIG. 3 has a 0-system interface 201 and a 1-system interface 211 respectively receiving the 0-system optical transmission signal and the 1-system optical transmission signal. An overhead processor 202 and a 0-system memory 203 are serially and sequentially connected to the 0-system interface 201, and an overhead processor 212 and a 1-system memory 213 are serially and sequentially connected to the 1-system interface 211.

A selector 208 is commonly connected to the 0-system memory 203 and the 1-system memory 213.

Also, a J1 multi-counter 204 and an F2 multi-counter 205 respectively detecting the J1 byte and the F2 byte of each frame are connected to the overhead processor 202, and a frame synchronous counter 206 is connected to the J1 multi-counter 204 and the F2 multi-counter 205.

Similarly, a J1 multi-counter 214 and an F2 multi-counter 215 respectively detecting the J1 byte and the F2 byte of each frame are connected to the overhead processor 212, and a frame synchronous counter 216 is connected to the J1 multi-counter 214 and the F2 multi-counter 215.

Also, a memory controller 207 is commonly connected to the frame synchronous counters 206 and 216, as well as the 0-system memory 203 and the 1-system memory 213.

It is to be noted that the J1 multi-counters 204, 214, the F2 multi-counters 205, 215, and the frame synchronous counters 206, 216 compose a phase difference detector 209.

Accordingly, when the receiver 200 receives the transmission signal forming a multiframe as shown in e.g. FIGS. 1A-1D, the J1 multi-counters 204, 214, and the F2 multi-counters 205, 215 read out the phase information from the J1 byte and the F2 byte for the 0-system optical transmission signal and the 1-system optical transmission signal respectively. The memory controller 207 provides the phase adjustment signals to the 0-system memory 203 and the 1-system memory 213 according to this information, so that the transmission signals are synchronized when the transmission signals are outputted from the memories 203 and 213.

Therefore, by operating the selector 208 at a high speed, the uninterruptible switching can be realized.

Triggers for the switching are as follows:
(1) At a time when a transmission line fault, namely an error occurs within a section interval or a path interval.
(2) At a time when a fault occurs in the transmitter of the working system or the protection system on transmission side.
(3) At a time when a fault occurs in the receiver of the working system or the protection system on the receiving side.
(4) At a time when there is a switchover due to a system control of a system change command and the like forced by a maintenance person.

It is to be noted that when the value of the F2 byte is all “1” or “0” or unsettled at all times, the F2 multi-counters 205 and 215 cannot detect the phase information of the F2 byte. In this case, the F2 multi-counters 205 and 215 respectively provide an alarm signal to the frame synchronous counters 206 and 216, so that the frame synchronous counters 206 and 216 use only the phase information of the 64-multiframe of the J1 byte, thereby enabling the upward compatibility. Namely, even if the opposing transmitter does not have the arrangement of the embodiment shown in FIG. 2, at least the 64-multiframe synchronization by the J1 byte can be established.

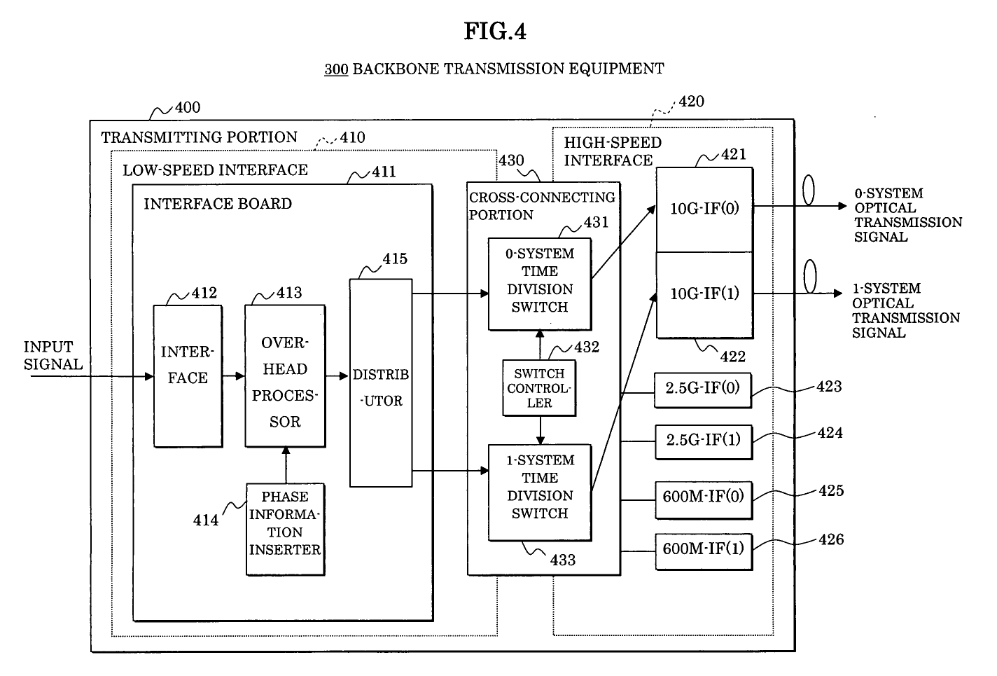

FIG. 4 shows a modification of the transmitter of the present invention adapted to the transmission side of a backbone transmission equipment. A transmitting portion 400 of a backbone transmission equipment 300 shown in FIG. 4 is composed of a low-speed interface 410 and a high-speed interface 420, and the low-speed interface 410 has an interface board 411 mounted thereon. Also, the high-speed interface 420 has high-speed interface boards of the working system and the protection system according to the speeds such as 10G, 2.5G, 600M, and the like. Namely, 10G interfaces 421, 422, 2.5G interfaces 423, 424, and 600M interfaces 425, 426 are mounted thereon. In FIG. 4, “(0)” and “(1)” within the interfaces 421-426 indicate the distinction between the 0-system and the 1-system respectively.

It is to be noted that in addition to the speeds shown in FIG. 4, any speeds defined by the SDH can be used for the high-speed interface boards mounted on the high-speed interface.

A cross-connecting portion 430 connects the low-speed interface 410 and the high-speed interface 420, and consists of a 0-system time division switch 431 and a 1-system time division switch 433 which are time-division-controlled by a switch controller 432.

Among these, the transmitter of the present invention is applied to the interface board 411. Namely, the interface board 411 is provided with an interface 412, an overhead processor 413, a phase information inserter 414, and a distributor 415. The phase information inserter 414 has the arrangement similar to the phase information inserter 110 shown in FIG. 2.

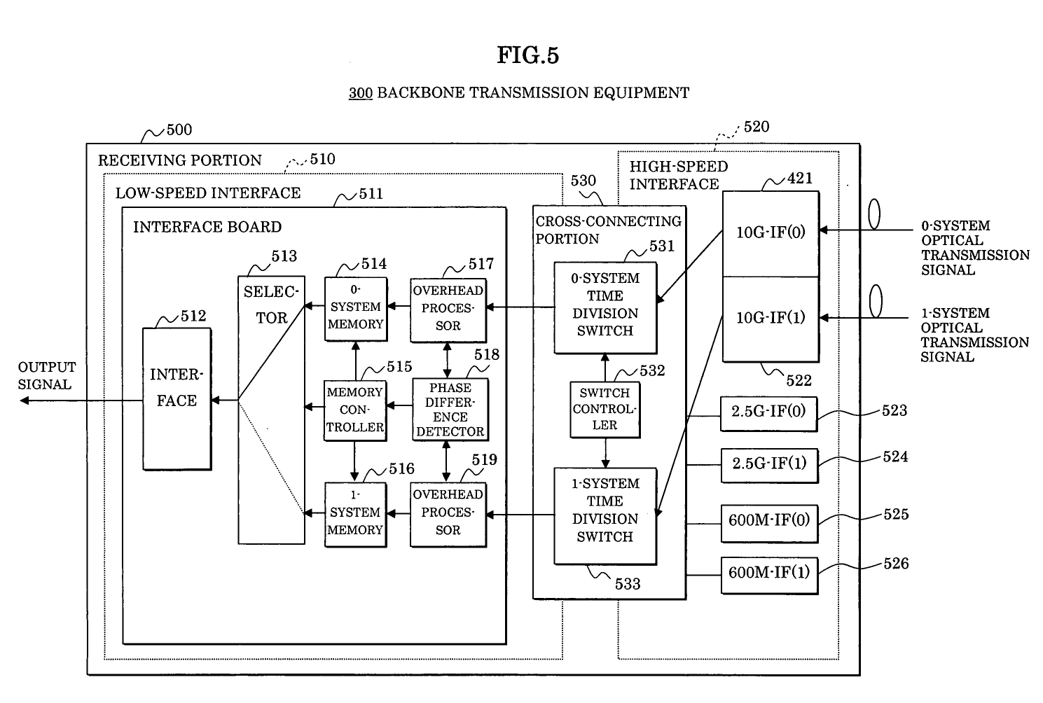

FIG. 5 shows a modification of a receiver of the present invention applied to the reception side of the backbone transmission equipment. A receiving portion 500 of the backbone transmission equipment 300 shown in FIG. 5 is composed of a low-speed interface 510 and a high-speed interface 520, and the low-speed interface 510 has an interface board 511 mounted thereon. Also, the high-speed interface 520 has high-speed interface boards of the working system and the protection system according to the speeds such as 10G, 2.5G, 600M, and the like. Namely, 10G interfaces 521, 522, 2.5G interfaces 523, 524, and 600M interfaces 525, 526 are mounted thereon.

It is to be noted that similar to the interfaces 421-426 in the transmitting portion 400 shown in FIG. 4, “(0)” and “(1)” within the interfaces 521-526 indicate the distinction between the 0-system and the 1-system respectively and in addition to the speeds shown in FIG. 5, any speeds defined by the SDH can be used for the high-speed interface boards mounted on the high-speed interface.

A cross-connecting portion 530 connects the low-speed interface 510 and the high-speed interface 520, and consists of a 0-system time division switch 531 and a 1-system time division switch 533 which are time-division-controlled by a switch controller 532.

Among these, the receiver of the present invention is applied to the interface board 511. Namely, the interface board 511 is equipped with overhead processors 517, 519, a 0-system memory 514, a 1-system memory 516, a phase difference detector 518, a memory controller 515, a selector 513, and an interface 512. The phase difference detector 518 has the arrangement similar to the phase difference detector 209 shown in FIG. 3.

1. A communication method comprising the steps of:
sequentially inserting, on a transmission side, phase information divided respectively into at least two predetermined bytes within a path overhead for each single frame of a transmission signal so as to compose a multiframe;
branching the transmission signal into transmission lines of a working system and a protection system to be transmitted;
detecting, on a reception side, a phase difference between the branched transmission signals of the working system and the protection system based on the phase information detected for each of the predetermined bytes in the branched transmission signals respectively received from the transmission lines of the working system and the protection system;
storing the branched transmission signals respectively in memories of the working system and the protection system;
providing phase adjustment signals to the memories of the working system and the protection system based on the phase difference;
outputting the transmission signals in an in-phase state from the memories of the working system and the protection system based on the phase adjustment signals; and
selecting the transmission signal outputted from one of the memories of the working system and the protection system.

2. The communication method as claimed in claim 1 wherein the predetermined bytes include at least a J1 byte and an F2 byte, and the multiframe comprises tiers of 64-multiframes by the J1 byte assembled by an arbitrary number of tiers identifiable by at least the F2 byte.

3. The communication method as claimed in claim 2, further comprising the step of setting and changing the arbitrary number of tiers on the transmission side.

4. A transmission method comprising the steps of:
sequentially inserting phase information divided respectively into at least two predetermined bytes within a path overhead for each single frame of a transmission signal so as to compose a multiframe; and
branching the transmission signal into transmission lines of a working system and a protection system to be transmitted.

5. A reception method comprising the steps of:
detecting a phase difference between transmission signals of a working system and a protection system based on phase information of a multiframe detected per at least two predetermined bytes within a path overhead for each single frame of the transmission signals respectively received from transmission lines of the working system and the protection system;
storing the transmission signals respectively in memories of the working system and the protection system;
providing phase adjustment signals to the memories of the working system and the protection system based on the phase difference;
outputting the transmission signals in an in-phase state from the memories of the working system and the protection system based on the phase adjustment signals; and
selecting the transmission signal outputted from one of the memories of the working system and the protection system.

6. A communication apparatus comprising:
a phase information inserter sequentially inserting, on a transmission side, phase information divided respectively into at least two predetermined bytes within a path overhead for each single frame of a transmission signal so as to compose a multiframe;
a distributor branching the transmission signal into transmission lines of a working system and a protection system to be transmitted;
a phase difference detector detecting, on a reception side, a phase difference between the branched transmission signals of the working system and the protection system based on the phase information detected for each of the predetermined bytes in the branched transmission signals respectively received from the transmission lines of the working system and the protection system;
a memory controller outputting phase adjustment signals of the working system and the protection system based on the phase difference;
memories of the working system and the protection system respectively storing the transmission signals of the working system and the protection system and then respectively outputting the transmission signals in an in-phase state based on the phase adjustment signals; and
a selector selecting the transmission signal outputted from one of the memories of the working system and the protection system.

7. The communication apparatus as claimed in claim 6 wherein the predetermined bytes include at least a J1 byte and an F2 byte, and the multiframe comprises tiers of 64-multiframes by the J1 byte assembled by an arbitrary number of tiers identifiable by at least the F2 byte.

8. The communication apparatus as claimed in claim 7, further comprising means setting and changing the arbitrary number of tiers on the transmission side.

9. A transmission apparatus comprising:
a phase information inserter sequentially inserting phase information divided respectively into at least two predetermined bytes within a path overhead for each single frame of a transmission signal so as to compose a multiframe; and
a distributor branching the transmission signal into transmission lines of a working system and a protection system to be transmitted.

10. The transmission apparatus as claimed in claim 9 wherein the predetermined bytes include at least a J1 byte and an F2 byte; and the phase information inserter comprises at least a first and second insertion counters respectively providing a first and second counts as the phase information to be inserted into the J1 byte and the F2 byte, and a counter controller controlling operations of the first and second insertion counters so as to compose the multiframe.

11. The transmission apparatus as claimed in claim 10, further comprising a setting portion setting a maximum value of the second insertion counter.

12. A reception apparatus comprising:
a phase difference detector detecting a phase difference between transmission signals of a working system and a protection system based on phase information of a multiframe detected per at least two predetermined bytes within a path overhead for each single frame of the transmission signals respectively received from transmission lines of the working system and the protection system;
a memory controller outputting phase adjustment signals of the working system and the protection system based on the phase difference;
memories of the working system and the protection system respectively storing the transmission signals of the working system and the protection system and then respectively outputting the transmission signals in an in-phase state based on the phase adjustment signals; and
a selector selecting the transmission signal outputted from one of the memories of the working system and the protection system.

13. The reception apparatus as claimed in claim 12 wherein the predetermined bytes include at least a J1 byte and an F2 byte; and the phase difference detector comprises, in each of the working system and the protection system, at least a first and second detection counters respectively detecting the phase information from the J1 byte and the F2 byte of the transmission signal as a first and second counts, and a third detection counter detecting phase information of the multiframe based on the first and second counts.

14. The reception apparatus as claimed in claim 13 wherein when the second detection counter notifies the third detection counter that the phase information is not inserted in the F2 byte, the third detection counter detects the phase information of the multiframe based on only the first count.
